(19) United States
(12) Patent Application Publication
(10) Pub. No.: US 2024/0414336 A1
(43) Pub. Date: Dec. 12, 2024

(54) DEPTH MOTION BASED MULTI-TYPE TREE SPLITTING

(71) Applicant: INTERDIGITAL CE PATENT HOLDINGS, SAS, Paris (FR)

(72) Inventors: Saurabh Puri, Saint-Lazare (CA); Karam Naser, Mouazé (FR); Tangi Poirier, Thorigné-Fouillard (FR); Gaëlle Martin-Cocher, Toronto (CA)

(73) Assignee: InterDigital CE Patent Holdings, SAS, Paris (FR)

(21) Appl. No.: 18/699,242

(22) PCT Filed: Oct. 5, 2022
(86) PCT No.: PCT/EP2022/077677

§ 371 Date: Apr. 5, 2024

(30) Foreign Application Priority Data
Oct. 5, 2021 (EP) 21306390.2

(51) Int. Cl. H04N 19/119; H04N 19/176

(52) U.S. Cl. CPC H04N 19/119; H04N 19/176

(57) ABSTRACT

Systems, methods, and instrumentalities are disclosed herein for determining the partitioning type of a video block based on depth and/or motion information associated with the video block. The depth and/or motion information may be obtained by a coding device such as an encoder in addition to the video block. Utilizing the depth and/or motion information, the coding device may be able to accelerate the partitioning determination process and obtain coding gains without incurring a significant increase in coding complexity.

### CROSS REFERENCE TO RELATED APPLICATIONS

This application claims priority to EP Provisional Patent Application No. 21306390.2, filed on Oct. 5, 2021, and entitled “DEPTH MOTION BASED MULTI-TYPE TREE SPLITTING,” the entirety of which is incorporated by reference as if fully set forth herein.

### BACKGROUND

Video encoding and/or decoding may involve partitioning (e.g., splitting) coding blocks. These partitioning and/or splitting operations may provide substantial coding gains but may also add complexity and costs to a coding device (e.g., such as an encoder). It is therefore desirable for the coding device to improve the speed of these operations and the overall coding gains, without incurring a significant increase in coding complexity.

### SUMMARY

Systems, methods, and instrumentalities are disclosed for determining a partitioning (e.g., splitting) type for a video block. A device, such as a video decoding device, or a video encoding device, may determine the partitioning type associated with the video block based on motion information and/or depth information associated with the video block.

For example, the device may obtain motion information associated with a video block. Based on at least the motion information, the device may determine the partitioning type associated with the video block and process (e.g., encode and/or decode) the video block in accordance with the determined partitioning type.

In examples, the device may determine a motion variance of the motion information associated with the video block and determine whether to split the video block based on the motion variance. Based on a condition that the motion variance indicates that the motion information associated with the block is homogeneous, the partitioning type for the video block may be determined to be non-split. Based on a condition that the motion variance indicates that the motion information associated with the block is not homogeneous, the partitioning type for the video block may be determined to be split, and a split direction may be determined. Whether the motion information associated with the block is homogeneous can be determined by comparing the motion variance to a value (e.g., a threshold value).

For example, a video decoding device may obtain an indicator indicative of whether motion-derived split mode is enabled for the video block. Based on a condition that the indicator indicates that motion-derived split mode is enabled for the video block, the video decoding device may obtain motion information associated with the video block and determine the partitioning type associated with the video block based on the motion information. Based on the indicator indicating that motion-derived split mode is disabled for the video block, the video decoding device may obtain the partition type for the video block based on a partition type indication associated with the video block (e.g., in video data such as a bitstream).

For example, a video encoding device may determine whether to enable motion-derived split mode. Upon determining to enable the motion-derived split mode for the video block, the video encoding device may obtain motion information and determine the partitioning type associated with the video block based on motion information. Upon determining to disable the motion-derived split mode for the video block, the video encoding device may include an indication of the partition type associated with the video block in video data.

For example, the device may obtain depth information associated with a video block. Based on at least the depth information, the device may determine the partitioning type associated with the video block and process (e.g., encode and/or decode) the video block in accordance with the determined partitioning type.

In examples, the device may determine a depth variance of the depth block associated with the video block and determine whether to split the video block based on the depth variance. Based on a condition that the depth variance indicates that the depth block associated with the block is homogeneous, the partitioning type for the video block may be determined to be non-split. Based on a condition that the depth variance indicates that the depth block is not homogeneous, the partitioning type for the video block may be determined to be split, and a split direction may be determined. Whether the depth block is homogeneous may be determined by comparing the depth variance to a value (e.g., a threshold value).

For example, the device may obtain a depth block associated with the video block. The device may segment the depth block based on binary segmentation and determine the partitioning type of the video block based on the binary segmented depth block. For example, a gradient associated with the binary segmented depth block may be obtained, and the partitioning type of the video block may be determined based on at least the gradient associated with the binary segmented depth block. For example, the device may detect an edge in the depth block based at least on a vertical gradient and a horizontal gradient of the depth block and determine the partitioning type of the video block based on the position of the edge in the depth block. For example, the device may split the depth block into parts, determine respective scores associated with the different parts based at least in part on comparing the sums of pixel depth values in the parts, and determine the partitioning type based on the respective scores.

For example, a video decoding device may obtain an indicator indicative of whether depth-derived split mode is enabled for the video block. Based on a condition that the indicator indicates that depth-derived split mode is enabled for the video block, the video decoding device may obtain depth information associated with the video block and determine the partitioning type associated with the video block based on the depth information. Based on the indicator indicating that depth-derived split mode is disabled for the video block, the video decoding device may obtain the partition type for the video block based on a partition type indication associated with the video block (e.g., in video data such as a bitstream).

For example, a video encoding device may determine whether to enable depth-derived split mode. Upon determining to enable the depth-derived split mode for the video block, the video encoding device may obtain depth information and determine the partitioning type associated with the video block based on depth information. Upon determining to disable the depth-derived split mode for the video block, the video encoding device may include an indication of the partition type associated with the video block in video data.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoding device (e.g., an encoder).

FIG. 3 illustrates an example video decoding device (e.g., a decoder)

FIG. 4 illustrates an example of a system in which various aspects and examples may be implemented.

FIG. 5 illustrates an example texture frame of a video game with a corresponding depth map, horizontal motion data, and vertical motion data that may be extracted from a game engine.

FIG. 6 illustrates an example architecture of a cloud gaming system, where a game engine may be running on a cloud server.

FIG. 7 illustrates example splitting types for intra and/or inter coded blocks.

FIG. 8 illustrates additional examples of splitting types.

FIG. 9 illustrates an example texture frame and a corresponding depth frame of a video game.

FIG. 10 illustrates an example intra frame, an example depth map corresponding to the intra frame, an example block partitioning structure, an example inter frame, an example depth map corresponding to the inter frame, and an example inter block partition structure.

FIG. 11 illustrates example operations that may be associated with partitioning type determination in accordance with one or more of the examples described herein.

FIG. 12 illustrates example operations that may be associated with depth-based partitioning type determination in accordance with one or more examples described herein.

FIG. 13 illustrates splitting a block in equal parts (e.g., four (4) equal parts) to compute a sum in a vertical direction and a horizontal direction.

FIG. 14 illustrates examples of areas that may be used to determine a partitioning type.

FIG. 15 illustrates an example of depth-based partitioning type determination without segmentation.

FIG. 16 illustrates how different regions may be defined for different partitioning types and used to determine a partitioning type.

FIG. 17 illustrates how a texture block may be used to determine a partitioning type.

FIG. 18 illustrates how a texture block and a depth block may be used to determine a partitioning type without segmentation.

FIG. 19 illustrates how a motion block and a depth block may be used to determine a partitioning type without segmentation.

FIG. 20 illustrates how depth information and motion information may be used to determine a partitioning type.

FIG. 21 illustrates an example advantage of using a motion block and a depth block to determine a partitioning type without segmentation.

FIG. 22 illustrates an example advantage of using a motion block and a depth block to determine a portioning type without segmentation.

FIG. 23 illustrates an example (e.g., for an encoding device or a decoding device) to determine a partitioning type.

### DETAILED DESCRIPTION

A more detailed understanding may be had from the following description, given by way of example in conjunction with the accompanying drawings.

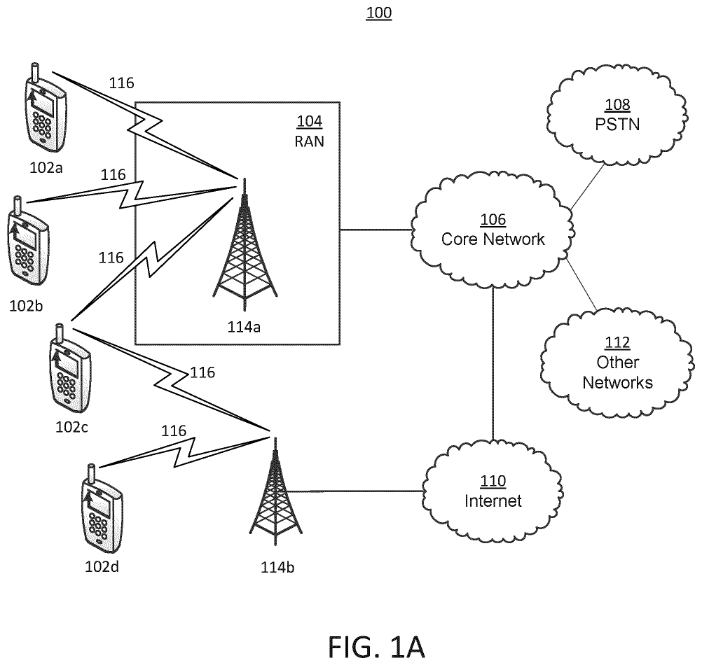

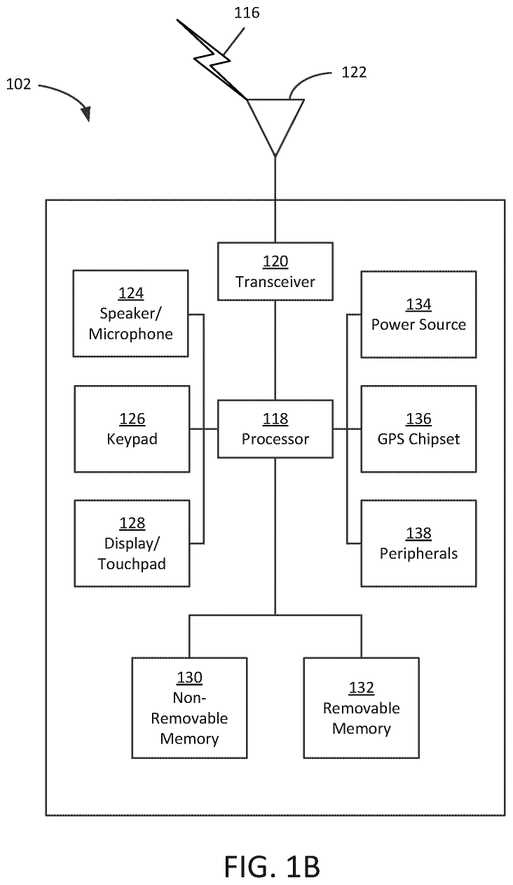

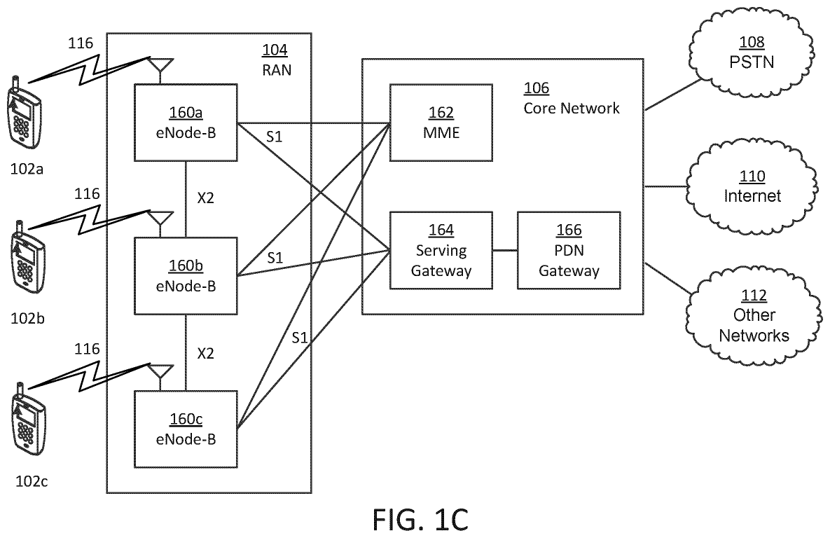

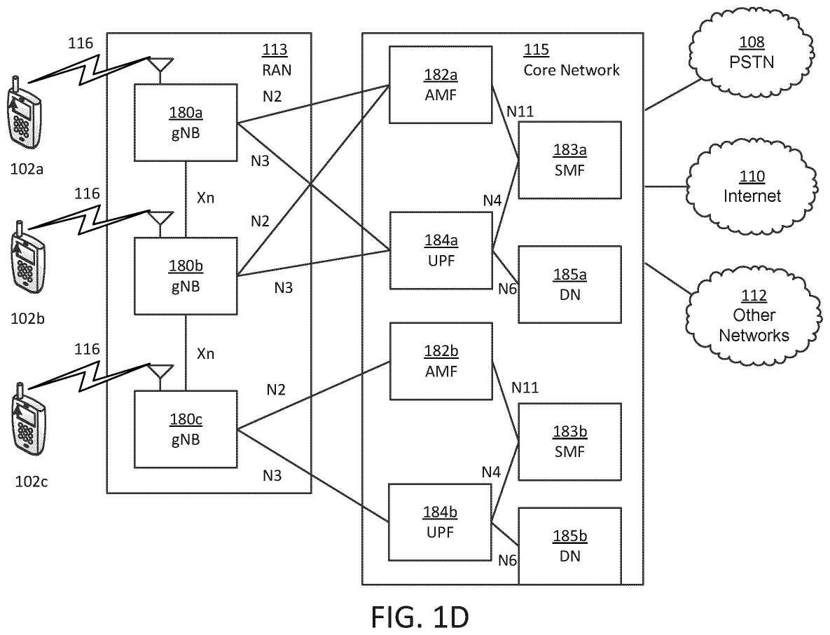

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

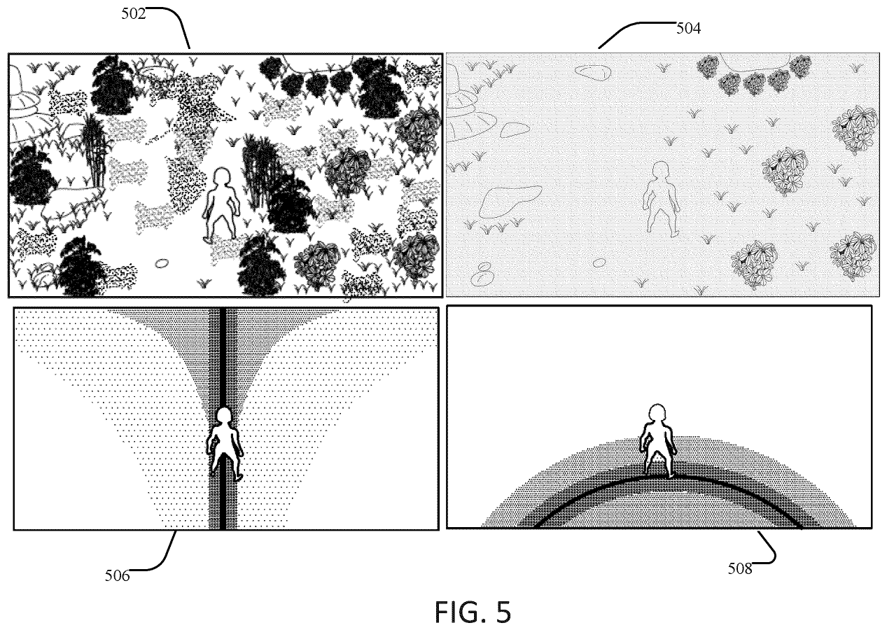

The aspects described and contemplated in this application may be implemented in many different forms. FIGS. 5-23 described herein may provide some examples, but other examples are contemplated. The discussion of FIGS. 5-23 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable medium (e.g., storage medium) comprising (e.g., having stored thereon) instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

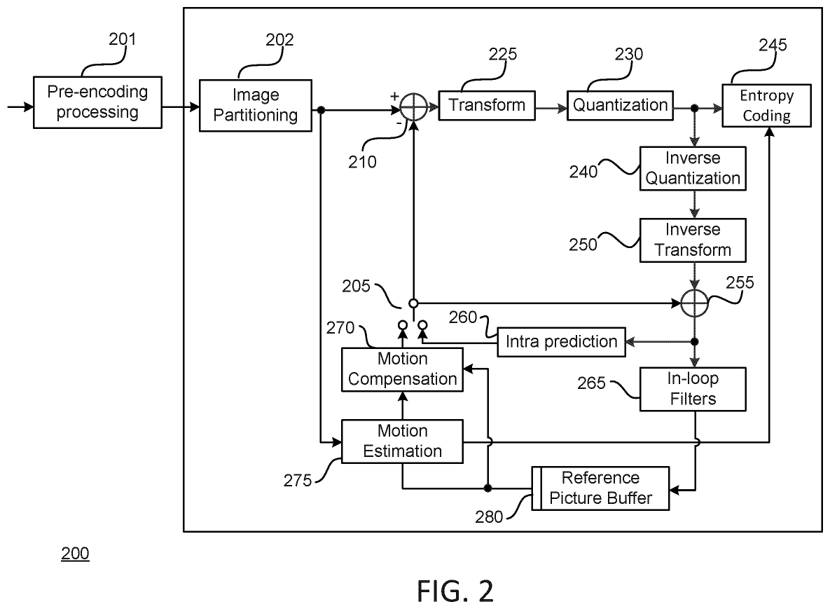

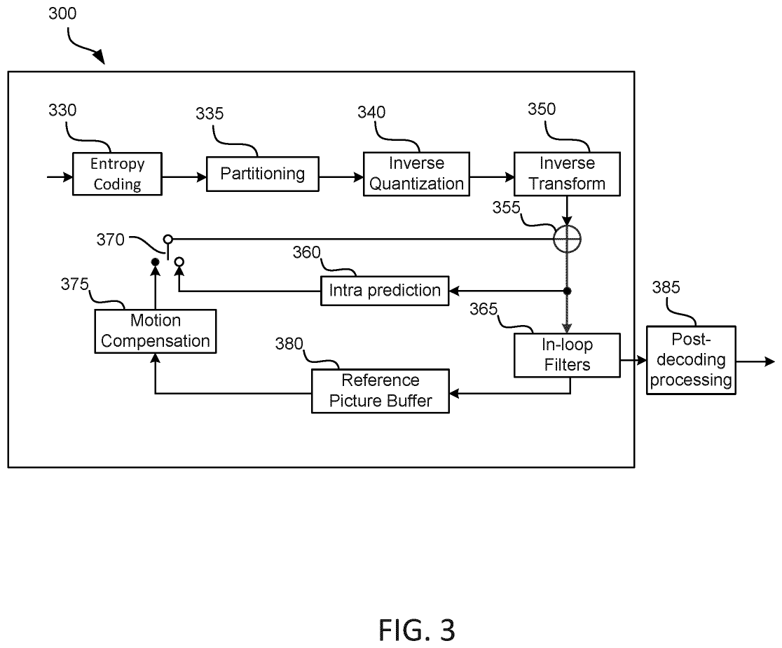

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format, or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as numbers of bits, bit depth, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing 201, for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing and attached to the bitstream.

In the encoder 200, a picture is encoded by the encoder elements as described below. The picture to be encoded is partitioned 202 and processed in units of, for example, coding units (CUs). Each unit is encoded using, for example, either an intra or inter mode. When a unit is encoded in an intra mode, it performs intra prediction 260. In an inter mode, motion estimation 275 and compensation 270 are performed. The encoder decides 205 which one of the intra mode or inter mode to use for encoding the unit, and indicates the intra/inter decision by, for example, a prediction mode flag. Prediction residuals are calculated, for example, by subtracting 210 the predicted block from the original image block.

The prediction residuals are then transformed 225 and quantized 230. The quantized transform coefficients, as well as motion vectors and other syntax elements, are entropy coded 245 to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized 240 and inverse transformed 250 to decode prediction residuals. Combining 255 the decoded prediction residuals and the predicted block, an image block is reconstructed. In-loop filters 265 are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded 330 to obtain transform coefficients, motion vectors, and other coded information. The picture partition information indicates how the picture is partitioned. The decoder may therefore divide 335 the picture according to the decoded picture partitioning information. The transform coefficients are de-quantized 340 and inverse transformed 350 to decode the prediction residuals. Combining 355 the decoded prediction residuals and the predicted block, an image block is reconstructed. The predicted block may be obtained 370 from intra prediction 360 or motion-compensated prediction (i.e., inter prediction) 375. In-loop filters 365 are applied to the reconstructed image. The filtered image is stored at a reference picture buffer 380.

The decoded picture can further go through post-decoding processing 385, for example, an inverse color transform (e.g., conversion from YCbCr 4:2:0 to RGB 4:4:4) or an inverse remapping performing the inverse of the remapping process performed in the pre-encoding processing 201. The post-decoding processing can use metadata derived in the pre-encoding processing and signaled in the bitstream. In an example, the decoded images (e.g., after application of the in-loop filters 365 and/or after post-decoding processing 385, if post-decoding processing is used) may be sent to a display device for rendering to a user.

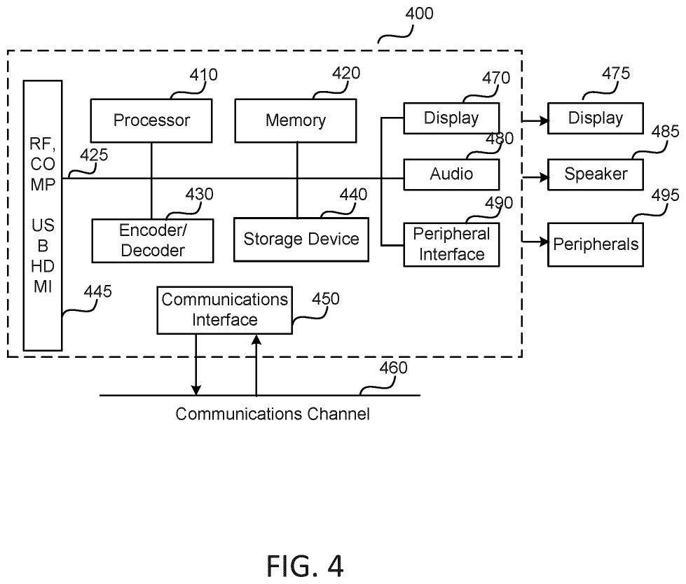

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video, or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations include decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations include encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, obtaining depth information associated with a video block, determining, based on at least the depth information, a partitioning type associated with the video block, processing the video block in accordance with the determined partitioning type, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on coding block partitioning, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, an encoding function on an input for a partitioning type, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions (e.g., computer-readable medium), medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

A video coding system (e.g., such as a cloud gaming server or a device with light detection (e.g., a mobile device) and ranging (LiDAR) capabilities) may receive input video frames (e.g., texture frames) and depth information (e.g., a depth map) and/or motion information (e.g., may receive input video frames with depth information and/or motion information). The depth information and/or motion information may be correlated. FIG. 5 illustrates an example texture frame 502 of a video game with a corresponding depth map 504, horizontal motion data 506, and vertical motion data 508 that may be extracted (e.g., directly) from a game (e.g., a game engine) rendering a game scene. The depth map 504 may be represented by a grey-level image indicating a distance between a camera and an actual object. The depth map 504 may represent a basic geometry (e.g., the basic geometry of a captured video scene). The depth map 504 may be associated with a texture picture of a video content and may include a dense monochrome picture of a resolution that may be similar to a luma picture (e.g., the same as a luma picture). The depth map 504 may have a resolution that may be similar to or different from a luma picture (e.g., the same as or different from a luma picture).

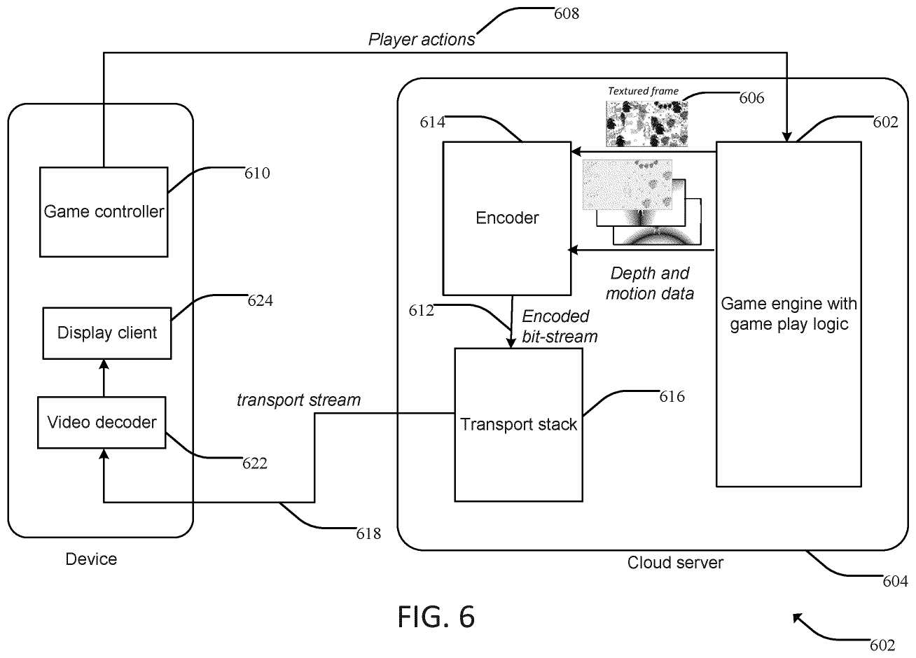

FIG. 6 shows an example architecture of a cloud gaming system 600, where a game engine 602 may be running on a cloud server 604. The gaming system may render a game scene 606 based on the player actions 608 (e.g., player actions that are received via user input from a game controller 610). The rendered game scene may be encoded into a bit-stream 612, for example, using a video encoder 614. The bit-stream may be encapsulated by a transport protocol (e.g., a transport stack 616) and may be sent as a transport stream 618 to the player's device 620. The player's device 620 may de-encapsulate and decode the transport stream 618 (e.g., using a video decoder 622) and present the decoded game scene to the player (e.g., using a display client 624).

As illustrated in FIG. 6, additional information such as a depth map, motion information, an object ID, an occlusion mask, camera parameters, etc., may be obtained from a game engine (e.g., as outputs of the game engine) and may be made available to the server device (e.g., an encoder of the server device) as prior information.

The information described herein such as the depth or motion information or a combination of both may be utilized to speed up (e.g., help speed up) the block partitioning operations on a video processing device (e.g., the encoder side of a video codec). Additionally, the information described herein, when available on both the processing device (e.g., the encoder side of a video coded) and decoding device (e.g., the decoder side of a video codec) may be used to infer block partitioning and achieve better compression efficiency. The block partitioning operations may be simplified utilizing such information while still preserving coding gains (e.g., compression gains).

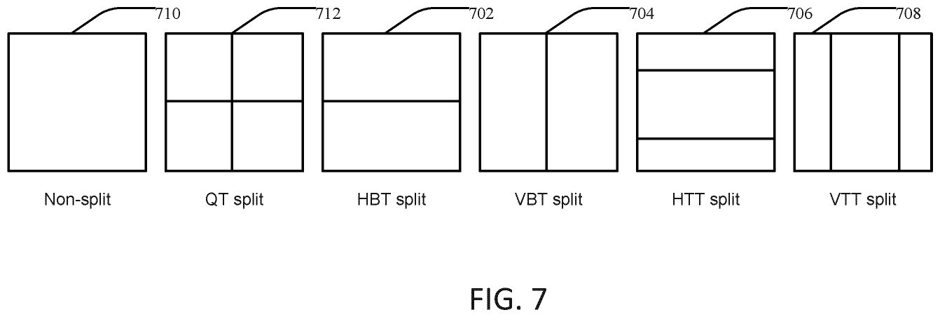

FIG. 7 shows example splitting types for intra and/or inter coded blocks. MTT partitioning may include one or more of a horizontal binary tree split (HBT) 702, a vertical binary tree split (VBT) 704, a horizontal ternary tree split (HTT) 706, or a vertical ternary tree split (VTT) 708. A block partitioning operation may be used where a coding tree unit (CTU) may be associated with (e.g., considered as) a single coding unit (CU), for example, if the CTU is not split 710, or if the CTU is recursively split (e.g., using a quaternary tree partitioning (QT) 712 first and then further recursively split using a multi-type tree partitioning (MTT).

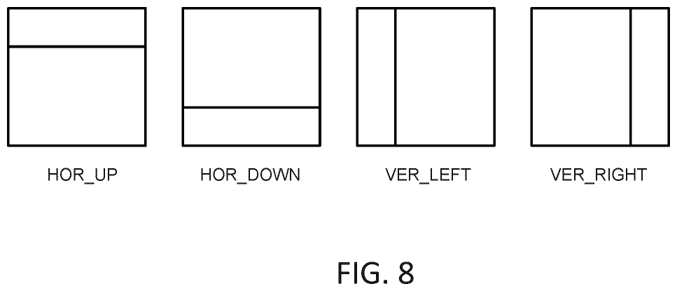

FIG. 8 shows splitting types (e.g., additional asymmetric binary tree (ABT) splitting modes) that may be considered as part of an MTT structure.

While the example MTT partitioning or splitting modes described herein may provide substantial coding gains (e.g., due to the added flexibility), the MTT partitioning or splitting modes may lead to increased coding complexity (e.g., on the encoder side) when using brute-force testing of each split type.

The term “split,” “split type,” “splitting type,” or “split mode” may be used interchangeably herein with the term “partition,” “partitioning type,” or “partitioning mode,” respectively.

The techniques described herein may accelerate the search (e.g., by an encoder) for a suitable (e.g., best possible) splitting type by allowing a coding device (e.g., an encoder) to make a fast MTT splitting decision for a given block (e.g., inside an encoder rate distortion optimization (RDO) loop). In examples, such techniques may utilize one or more of depth or motion information (e.g., one or more of co-located depth or motion information) or a combination of both, to make a decision (e.g., a smart decision on the split type (e.g., including a decision to not split (e.g., non-split)).

The techniques described herein may improve the overall coding speed (e.g., speed of the codec when compared to a coded that allows MTT) and coding gains without a significant increase in coding complexity.

In an example, depth or motion information may be available on a coding device (e.g., an encoder) and a decoding device (e.g., a decoder). Coding efficiency (e.g., coding gains) may be achieved without (e.g., by not) signaling block partition information and by inferring block partitioning on the decoding device (e.g., a decoder)

Fast block splitting techniques may be classified into multiple (e.g., two) categories. A category (e.g., a first category) may include techniques that may use features (e.g., hand-crafted features) extracted (e.g., extracted directly) from a video picture (e.g., a current frame or a past frame) to determine block partitioning. A category (e.g., a second category) may include techniques (e.g., deep learning methods) to extract (e.g., automatically extract) the features from a video picture block and output a (e.g., the best) block partitioning.

Techniques that utilize a convolutional neural network (CNN) may experience high complexity (e.g., may experience issues associated with high complexity) and may be difficult to implement in real-time encoders. Techniques that use texture data (e.g., hand-crafted texture data) may be limited, for example, by how the features may correlate (e.g., how well the features may correlate) with the decision (e.g., the actual decision) on whether to split. It may be difficult (e.g., computationally demanding) to extract multiple features from a texture frame (e.g., from texture data), and the encoding time gains may be limited.

A texture block partitioning may be predicted based on the edges in a depth map. Such a depth map may not be encoded (e.g., encoded into video data (e.g., a bitstream)) and may be used to determine a suitable (e.g., a best) MTT partition or split at an encoder.

Techniques described herein may predict a texture block partitioning based at least in part on edges in a depth map. A “texture block” and a “video block” may be used interchangeably as described herein. In some examples, depth information (e.g., a depth block, a depth map) may be coded and indicated in video data. In some examples, depth information may not be coded and may be used to determine the best MTT split at the coding device (e.g., the encoder, and/or the decoder).

Depth information or motion information or a combination of both may be used by (e.g., may be provided to) a coding device (e.g., an encoder and/or a decoder) as an input for fast block partitioning. Such information may be easy to handle and may not be difficult (e.g., computationally extensive) to extract features.

Depth and/or motion based multi-type tree (DM-MTT) splitting (e.g., partitioning) may be employed to process a given coding block (e.g., a texture coding block). Using a DM-MTT splitting technique, a coding device (e.g., an encoder or a decoder) may obtain depth and/or motion information (e.g., co-located depth and/or motion vector information) and determine a suitable (e.g., a best) MTT split type for a coding block (e.g., a textured coded block). The MTT split type (e.g., the determined MTT split type) may be appended to a list of coding modes (e.g., other coding modes) that may be tested by the coding device, for example, inside a rate-distortion optimization (RDO) loop. In examples, the depth and/or motion information may be obtained by the coding device from a content source such as a game engine. In examples, the depth and/or motion information may be obtained by the coding device from video data (e.g., the depth and/or motion information may be encoded into a bitstream and reconstructed and used by a decoder). In examples, a partitioning type (e.g., a DM-MTT partitioning or splitting type) may be signed in a bitstream (e.g., together with encoded video contents) and used by a receiving device (e.g., a decoder) for decoding the video contents.

Depth information may be provided (e.g., as an input) to a coding device such as an encoder to perform DM-MTT. DM-MTT may be performed in different manners (e.g., operations) including, for example, one or more of determining (e.g., detecting) an MTT split type based on a binary depth map (e.g., based on an edge orientation or edge position (e.g., in the binary depth map)), based on a calculated difference between multiple (e.g. 4) areas of the binary depth map, etc.), determining an MTT split type without computation of a binary map (e.g., a binary map of depth), performing MTT splitting based on depth-assisted texture (e.g., by omitting a binary segmentation step), performing MTT splitting based on depth and/or motion in the inter mode and/or using a motion vector as an input (e.g., an additional input) to the coding device (e.g., upon determining a correlation between the gradients of depth and motion), or not performing a split (e.g., non-split).

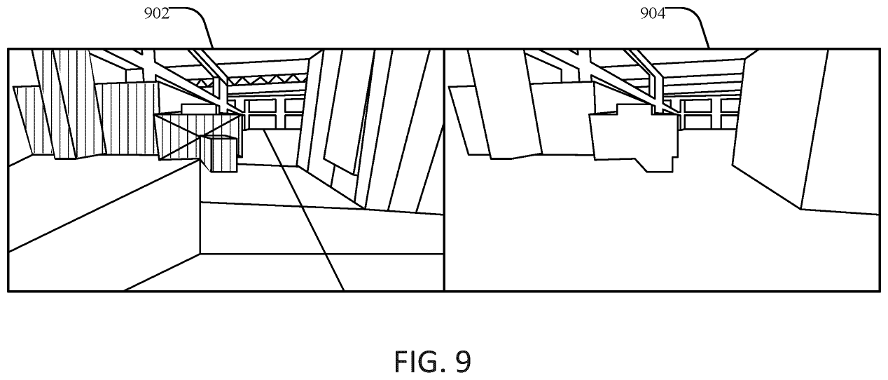

FIG. 9 shows an example texture frame 902 and a corresponding depth frame (e.g., depth map) 904 of a video game. The boundaries (e.g., sharp boundaries) on the texture frame 902 (e.g., textual blocks in the texture frame) may be associated with (e.g., highly correlated with) the edges on the depth map 904. The depth map 904 may contain information that may be used to separate objects in the foreground from objects in the background. Such information may facilitate the determination of whether to split a given texture block.

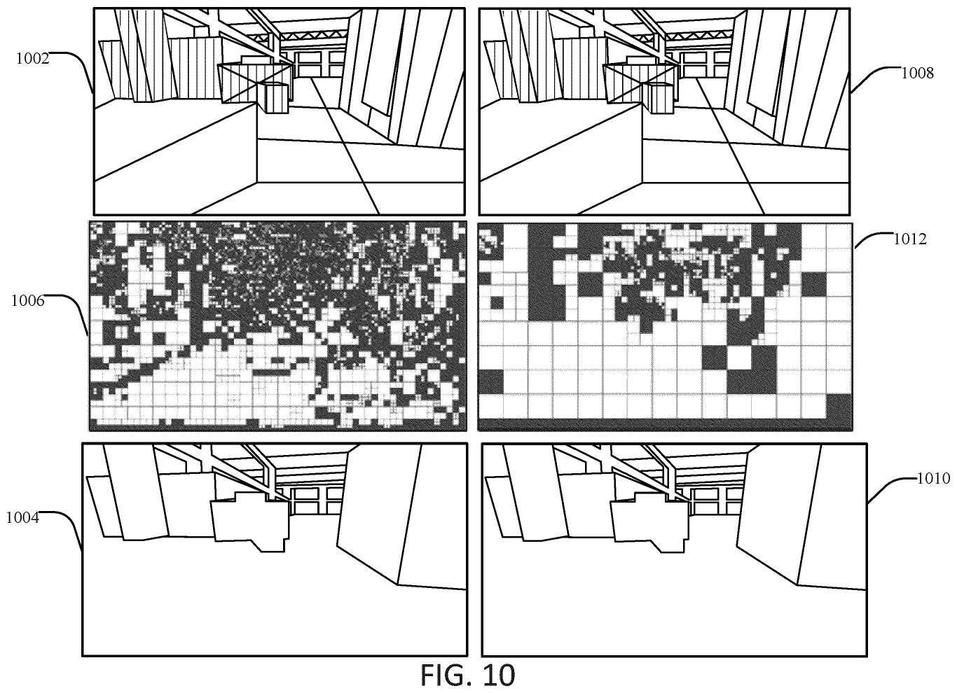

FIG. 10 shows an example intra frame 1002, an example depth map 1004 corresponding to (e.g., co-located with) the intra frame 1002, an example block partitioning structure 1006, an example inter frame 1008, an example depth map 1010 corresponding to (e.g., co-located with) the inter frame 1008, and an example inter block partition structure 1012. MTT splits such as a binary tree split (BT) and a ternary tree split (TT) (e.g., MTT blocks obtained using these split types) may be highlighted by the darker areas in 1006 and 1012.

FIG. 10 illustrates that MTT partitions (e.g., MTT blocks) around edges may be visible (e.g., more visible) in the case of inter prediction. MTT partitions (e.g., MTT blocks) around edges may be visible (e.g., more visible) in the case of inter prediction because an inter prediction may fail around the object boundaries where motions of the objects in the foreground and those in the background may not be correlated (e.g., may not be well correlated). Depth and/or motion data may provide information regarding the background and the foreground as well as their corresponding direction of motion, and may assist a coding device (e.g., an encoder) in deciding a suitable (e.g., best) partition for a given block, for example, without conducting an extensive RDO search.

A coding device (e.g., an encoder) may use MTT splitting to achieve coding gains (e.g., higher coding gains). The coding device may test a block T (e.g., a given block T) against one or more (e.g., against all) splitting options (e.g., the testing may be done in a brute-force fashion). The coding device may determine the split with a low RDO cost (e.g., the lowest RDO cost) and signal the determination to a receiving device (e.g., a decoder).

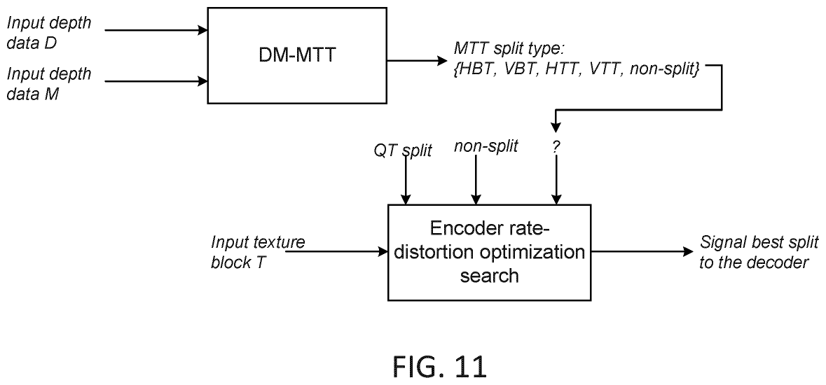

Depth, motion, or their combination may be provided (e.g., may be provided as an input) to a coding device (e.g., an encoder) for a given block, and the coding device may determine (e.g., may determine directly) an MTT split type or a non-split type based on the input. Using this technique, the coding device may not conduct (e.g., may not need to conduct) an expensive search (e.g., an encoder search) for an MTT split. The decision may be made fast (e.g., may speed up the coding device (e.g., the encoder). FIG. 11 illustrates a simplified (e.g., a high-level) block diagram illustrating example DM-MTT operations in accordance with one or more embodiments described herein.

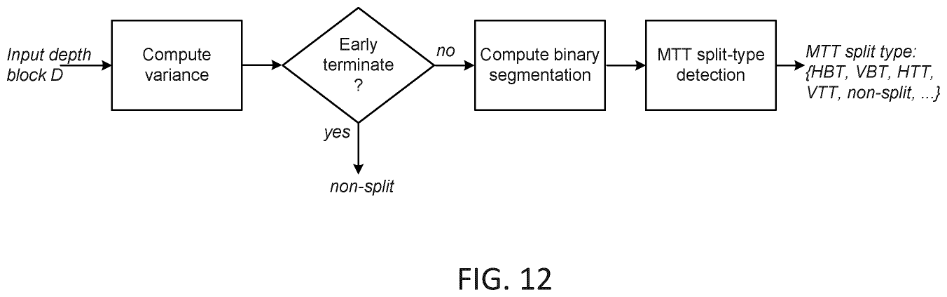

FIG. 12 shows a simplified block diagram illustrating example determining MTT split type based on depth information. As shown, a coding device (e.g., an encoder) may obtain depth information associated with the block, such as a depth block. The coding device may detect one or more homogeneous depth blocks using an early termination technique. For example, an early termination may be decided based on a variance (e.g., a difference in depth values) of a depth block. If the variance is below a threshold (e.g., if the variance is below a predetermined threshold), then the block may be considered homogeneous, the split type may be set to non-split, and the splitting operation may terminate (e.g., the splitting operation may terminate for that block). The coding device (e.g., the encoder) may segment a depth block, for example, using a binary segmentation method (e.g., various binary segmentation methods may be used to segment the depth block without affecting the applicability of the DM-MTT techniques described herein). The coding device (e.g., encoder) may then choose a partition structure (e.g., from multiple MTT structures) using a split-type detection method. As will be described in greater detail below, multiple split-type detection methods may be used to choose the partition structure (e.g., depending on the input type). Once an MTT split type is chosen (e.g., once a best MTT split type is chosen), the coding device may add the split type to a list of other coding modes that may be tested by the coding device (e.g., may be tested inside an RDO loop of the coding device).

A coding device such as an encoder may determine (e.g., compute) a suitable (e.g., best) MTT split type for a textured block T (e.g., a given textured block T) based on a binary segmented depth block or depth map (e.g., a binary segmented depth block or depth map associated with the given textured block). The coding device (e.g., the encoder) may perform one or more of the following. The coding device may determine respective sums (e.g., sums of gradients) on a binary segmented depth block (e.g., in a horizontal direction G_x and a vertical direction G_y). The coding device may compare the two gradients (e.g., the two sums) to determine a direction of split. The coding device may determine (e.g., select) a split type (e.g., BT or TT) based on a position (e.g., a position of a significant edge in a binary segmented depth block).

The sums of gradient for G_x and G_y may be computed as follows:

$$\begin{matrix}{G}_{x} = {\sum }_{i = 1}^{W} {\sum }_{j = 1}^{H} abs ( {g}_{x} ( i , j ) ) \\ {G}_{y} = {\sum }_{i = 1}^{W} {\sum }_{j = 1}^{H} abs ( {g}_{y} ( i , j ) )\end{matrix}$$

where W may be the width and H may be the height (e.g., the heigh of the input binary map), and gₓ and g_{y} may be computed as follows:

$$\begin{matrix}{g}_{x} = B \times [ \begin{matrix}- 1 & 1\end{matrix} ] \\ {g}_{y} = B \times [ \begin{matrix}- 1 \\ 1\end{matrix} ]\end{matrix}$$

where B may represent the binary map obtained (e.g., obtained from the segmented depth map).

The coding device (e.g., the encoder) may determine that the textured block (e.g., the given textured block) may be a homogeneous block and that the split type may be non-split, if the absolute difference between G_x and G_y is less than a threshold T₁ (e.g., less than a predetermined and/or certain threshold).

The coding device may determine (e.g., the coding device may compute) the position p of the edge (or gradient) from the left (for vertical edge) of the block or the top (for horizontal edge) of the block, and the coding device may further determine a split type based on the rules illustrated in Table 1 below.

TABLE 1
example split type detection rules

```
Compute Gₓ and G_{y}
if abs (Gₓ > G_{y}) < T₁ then
  split = non-split
Else
  if Gₓ > G_{y} then
    if p < w/4 or p > w * ¾ then
      split = VTT
    Else
      split = VBT
  Else
    if p < h/4 or p > H * ¾ then
      split = HTT
    Else
      split = HBT
```

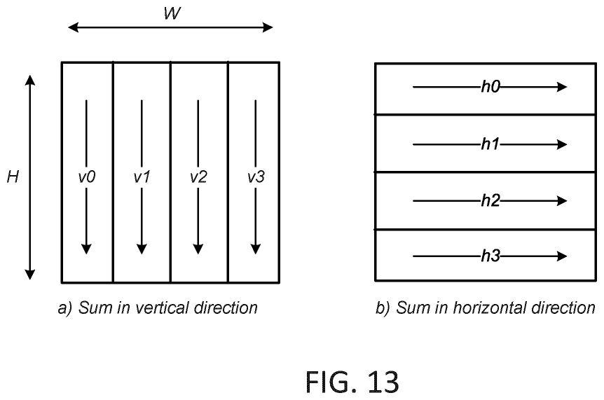

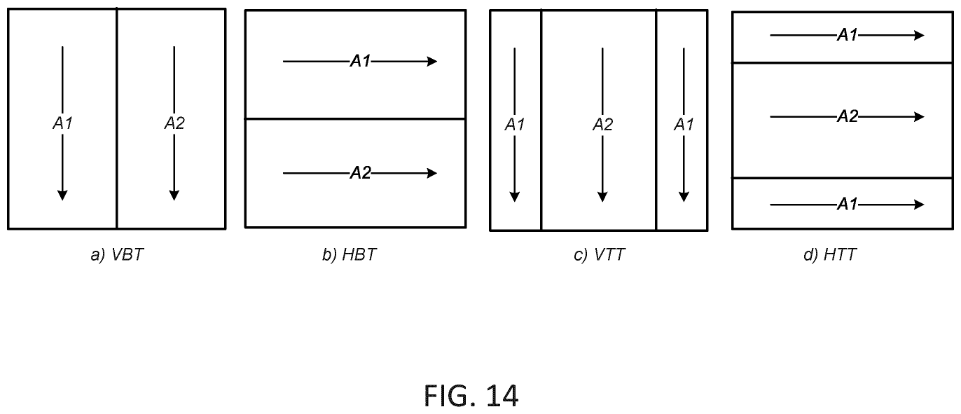

In examples, a coding device such as an encoder may determine an MTT split-type based on a binary depth map by performing one or more of the following. The coding device may divide a binary segmented depth block into four (4) parts (e.g., four (4) equal parts as in FIG. 13) in the horizontal and vertical directions and may determine and/or store the sum (e.g., the sum of binary values of each part). The coding device may determine respective scores for one or more split types (e.g., for each split type), for example, by calculating the absolute difference of sum of binary values of two (2) areas A1 and A2 defined by the split (e.g., the splits depicted in FIG. 14). The coding device may then determine a split type based on the determined scores.

FIG. 13 shows a simplified diagram illustrating block splitting in the vertical and horizontal directions. For the horizontal case, a sum of binary values (e.g., from quarters) may be stored in variable h₀, h₁, h₂ and h₃, respectively. For the vertical case, a sum of binary values (e.g., from quarters) may be stored in variable v₀, v₁, v₂ and v₃, respectively. A sum of all the binary values (e.g., a sum of all the binary values inside a block) may be stored (e.g., may be stored in a variable M).

FIG. 14 shows a simplified diagram illustrating examples of areas A1 and A2 for MTT split types. Scores described herein (e.g., for a given split type) may be computed as follows:

score=abs(sum of binary values in area A1−sum of binary values in area A2)

The scores for MTT split type VBT, HBT, VTT and HTT may be denoted as score₀, score₁, score₂, score₃ respectively, and the scores may be computed as follows:

$$\begin{matrix}{score}_{0} = abs ( M - 2 * ( {v}_{2} + {v}_{3} ) ) \\ \begin{matrix}{score}_{1} = abs ( M - 2 * ( {h}_{2} + {h}_{3} ) ) \\ {score}_{2} = abs ( M - 2 * ( {v}_{1} + {v}_{2} ) ) \\ {score}_{3} = abs ( M - 2 * ( {h}_{1} + {h}_{2} ) )\end{matrix}\end{matrix}$$

The MTT split type may be determined based on the rules illustrated in Table 2 below:

TABLE 2
example split type detection rules (e.g., based on difference in area)

```
1: Compute {v₁, v₂, v₃, v₄} , {h₀, h₁, h₂, h₃} and M for a given block
2: Calculate scores {score₀, score₁, score₂, score₃} for each split type
3: Determine split type (e.g., including and along with a special case of non-split)
{
  if max( score₀, score₁, score₂,score₃) − min( score₀, score₁, score₂, score₃) < T₂ then
    split = non-split
  else
    if ( score₀ > score₁) and ( score₀ > score₂) and (score₀ > score₃); then
      split = VBT
    if ( score₁ > score₀) and ( score₁ > score₂) and (score₁ > score₃); then
      split = HBT
    if ( score₂ > score₀) and ( score₂ > score₁) and (score₂ > score₃); then
      split = VTT
    if ( score₃ > score₀) and ( score₃ > score₁) and (score₃ > score₂); then
      split = HTT
}
```

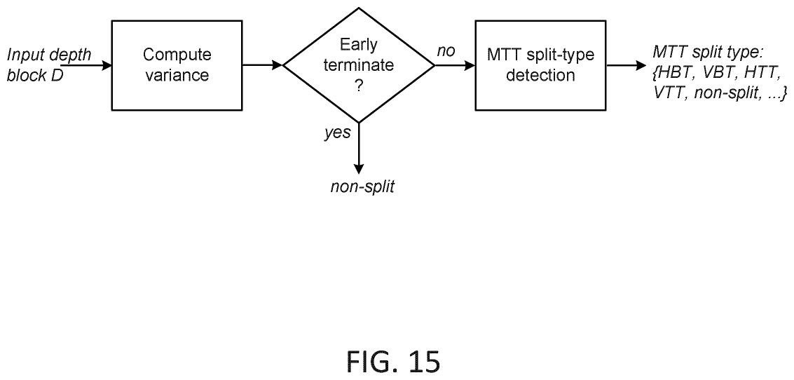

MTT split type detection may be performed (e.g., directly performed) based on depth data (e.g., without computation of a binary map). FIG. 15 shows a simplified diagram illustrating an example of depth-based MTT splitting, for example, without using a segmentation block.

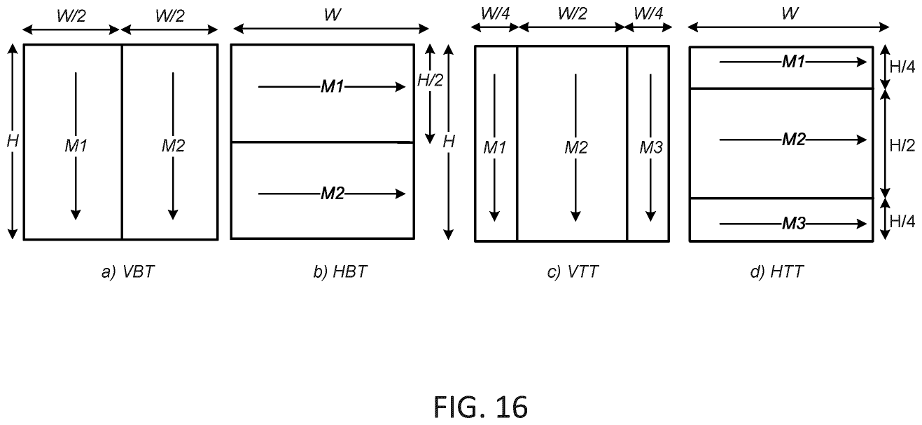

In the example of FIG. 15, mean values of an input depth block may be computed for one or more regions (e.g., for each region as in FIG. 16) that may be obtained from a given split. Scores may be calculated for a split type (e.g., each split type), for example, by subtracting the different regions. A split type may be determined by comparing the scores (e.g., the scores including a decision of non-split as described herein).

FIG. 16 illustrates how different regions may be associated with (e.g., how different regions may be defined for) different split types and their relationship with mean values M1, M2 or M3 computed on an input depth block (e.g., an input depth block for each region). For example, in binary splitting, mean values M1 and M2 may be computed for split region 1 and 2, respectively. For example, in ternary splitting, mean values M1, M2 and M3 may be computed for split region 1, 2 and 3, respectively. The mean values may be computed using the following formula:

$$mean M = \frac{sum of pixels in a region}{area of region}$$

The respective scores for different split types may be calculated as follows:

$$\begin{matrix}{score}_{0} = abs ( M 1 - M 2 ) \\ {score}_{1} = abs ( M 1 - M 2 ) \\ {score}_{2} = max ( abs ( M 1 - M 2 ) , abs ( M 3 - M 2 ) ) \\ {score}_{3} = max ( abs ( M 1 - M 2 ) , abs ( M 3 - M 2 ) )\end{matrix}$$

where score₀, score₁, score₂, score₃ may denote the scores for MTT split type VBT, HBT, VTT and HTT, respectively, and an MTT split type may be determined based on the rules illustrated in Table 3 below (e.g., applicable to a depth block, a texture block, and/or a motion block dependent on the input):

TABLE 3
example split type detection rules (e.g., based on different of means)

```
1: compute means for each region in a block (e.g., as shown in FIG. 16)
₂: calculate scores {score₀, score₁, score₂, score₃} for each split type
3: determine split-type along with a special case of non-split
{
  if max( score₀, score₁, score₂, score₃) − min( score₀, score₁, score₂,score₃) < T₃ then
      split = non-split
  Else
    if ( score₀ > score₁) and ( score₀ > score₂) and (score₀ > score₃); then
        split = VBT
    if ( score₁ > score₀) and ( score₁ > score₂) and (score₁ > score₃); then
        split = HBT
    if ( score₂ > score₀) and ( score₂ > score₁) and (score₂ > score₃); then
        split = VTT
    if ( score₃ > score₀) and ( score₃ > score₁) and (score₃ > score₂); then
        split = HTT
}
```

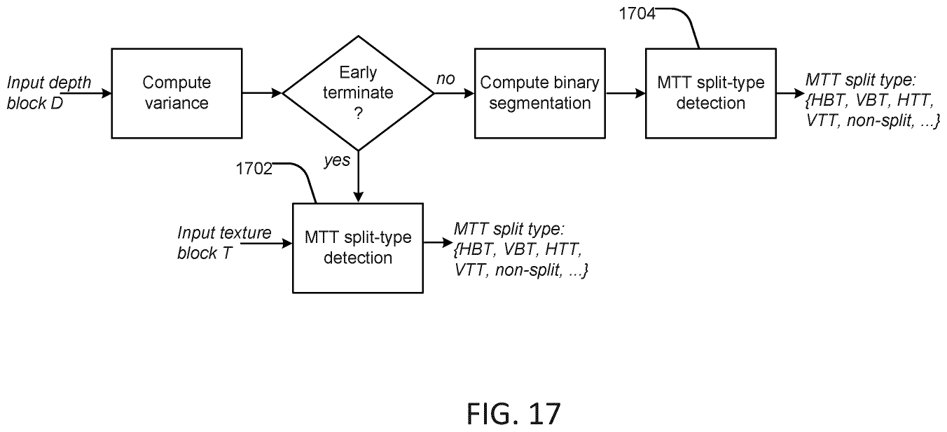

A texture block may be used to determine an MTT split type, for example, if an early termination decision is made (e.g., if an early termination decision is made based on a depth block). FIG. 17 illustrates an example of an early termination decision being made (e.g., an early termination decision being made based on a depth block).

In the example shown in FIG. 17, a coding device (e.g., an encoder) may check a depth block D for early termination based on a variance (e.g., a variance associated with the block), as described herein. Early termination may be decided (e.g., by the coding device). An MTT split type may be determined (e.g., detected), for example, by applying (e.g., at 1702) the rules shown in Table 3 on a texture block to determine a partition (e.g., out of multiple MTT split types). No early termination decision may be decided, and the depth block D may be binary segmented, and the rules shown in Table 1 or Table 2 may be applied (e.g., at 1704 on the depth block).

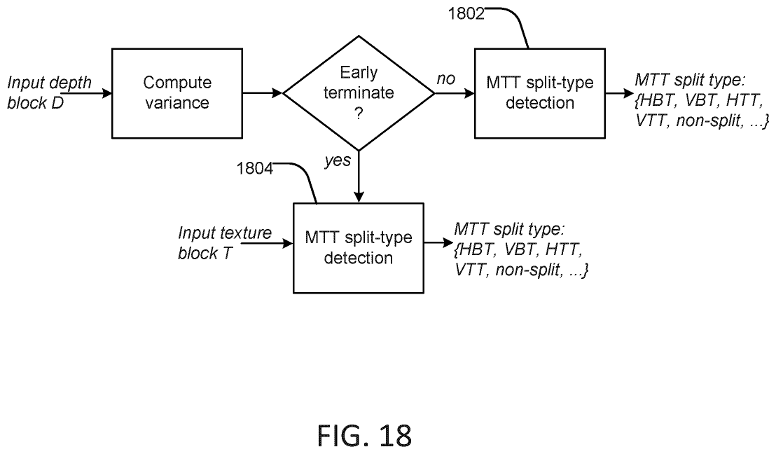

In examples, the binary segmentation operation on the depth block D described above may be omitted (e.g., removed), and the rules shown in Table 3 may be applied (e.g., directly) at 1802 on the depth block and at 1804 on the texture block to determine a partitioning. FIG. 18 illustrates that the rules shown in Table 3 may be applied at 1802 and 1804 and that an early termination decision may be made for the depth block D.

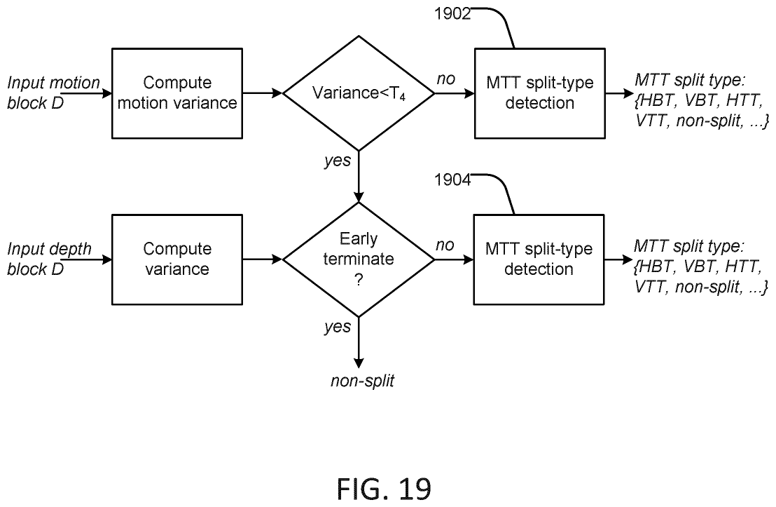

In examples (e.g., examples in the inter mode), a coding device (e.g., an encoder) may utilize motion information (e.g., motion information retrieved from a game engine) as an input to determine a split type. FIG. 19 shows an example of this.

In the example shown in FIG. 19, a motion block (e.g., a co-located motion block) may be used (e.g., in addition to a depth block) to determine an MTT split type. For a given textured block (e.g., an inter block), a variance (e.g., a variance associated with the motion block) may be computed. For example, an early termination decision may be made and/or splitting may be skipped, for example, if the variance is below a threshold T₄ (e.g., a predetermined threshold). Low variance may indicate that motion inside the motion block may be homogeneous. and the textured block may be predicted based on past frames (e.g., using a single motion vector).

The motion block may be non-homogeneous (e.g., the variance may be greater than the threshold T₄), and a horizontal and a vertical gradient may be computed for the motion block, and the horizontal and vertical gradient may be compared to determine a splitting direction (e.g., using similar techniques described herein for depth-based determination). For example, the rules shown in Table 3 may be applied at 1902 or 1904 of FIG. 19.

In examples (e.g., if depth and motion edges are not correlated), a motion block may be used to determine an MTT split type using one or more of the techniques described herein for a depth block.

In examples, a motion block may be non-homogeneous, and a correlation between the gradients in depth and motion may be determined. If the gradients are correlated, an MTT splitting technique described herein may be employed to determine a split type based on the depth block.

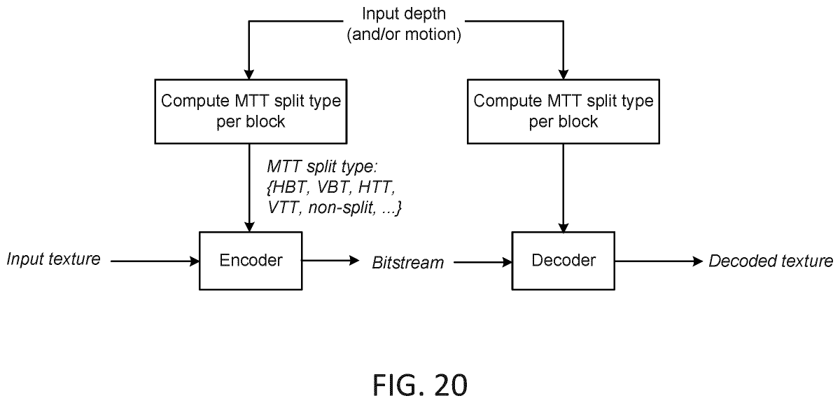

In the example illustrated in FIG. 20, depth and/or motion information (e.g., a depth and/or motion map) may be available to an encoding device and a decoding device. An MTT split type may be inferred by one or more of the encoding device or decoding device based on the depth and/or motion information. Better compression efficiency (e.g., reduced encoder time as well as reduced signaling cost) may be achieved by the example described herein because the MTT split type may not be signaled in video data (e.g., the bitstream).

In an example, using depth information (and/or motion information) to determine the MTT split type may be enabled or disabled (e.g., actively enabled or disabled) at one or more of an encoding device or a decoding device by an indicator (e.g., a high-level syntax flag called for example “use_additional_map_enabled”). The indicator may, for example, be indicated (e.g., signaled) at least at one or more of a picture of slice level (e.g., in a picture header or slide header) and may also be indicated (e.g., signaled) at a sequence level (e.g., in SPS or PPS).

In an example, the indicator may be enabled (e.g., the high-level flag may be enabled), and the enabling of the indicator may enable the use of depth information (and/or motion information) to determine the MTT split type at a CU (coding unit) level (e.g., at each CU level).

In an example, the use of depth information (and/or motion information) to determine the MTT split type may be enabled or disabled (e.g., actively enabled or disabled) at the CU level based on a CU level indicator (e.g., a CU level flag called for example “cu_use_additional_map_enabled”).

For example, the indicator may be obtained (e.g., by the decoding device) and may be indicative of whether depth-derived split mode is enabled. A determination of the partitioning type associated with the video block based on at least the depth information may be performed based on a condition that the indicator indicates that depth-derived split mode is enabled for the video block. For example, whether to obtain the depth information may be determined based on the indicator, and the depth information associated with the video block may be obtained based at least on the indicator indicating that depth-derived split mode is enabled for the video block.

In an example, an indicator indicative of whether depth-derived split mode is enabled for a video block may be obtained. For example, the indicator may indicate that depth-derived split mode is disabled for the video block. The partition type for the video block may be obtained based on a partition type indication associated with the block in video data (e.g., the bitstream).

For example, a video encoding device may determine whether to enable depth-derived split mode (e.g., based on RDO). Upon determining to enable the depth-derived split mode for the video block, the video encoding device may obtain depth information and determine the partitioning type associated with the video block based on depth information. Upon determining to disable the depth-derived split mode for the video block, the video encoding device may include an indication of the partition type associated with the video block in video data.

For example, the indicator may be obtained (e.g., by the decoding device) and may be indicative of whether motion-derived split mode is enabled, and determining the partitioning type associated with the video block based on the motion information may be performed based on a condition that the indicator indicates that motion-derived split mode is enabled for the video block.

Whether to obtain motion information may be determined (e.g., by the decoding device) based on the indicator. The motion information associated with the video block may be obtained based at least on the indicator indicating that motion-derived split mode is enabled for the video block.

An indicator may be indicative of whether motion-derived split mode is enabled for a video block. Based on the indicator indicating that motion-derived split mode is disabled for the video block, the partition type for the video block may be obtained based on a partition type indication associated with the block in video data (e.g., the bitstream).

For example, a video encoding device may determine whether to enable motion-derived split mode (e.g., based on RDO). Upon determining to enable the motion-derived split mode for the video block, the video encoding device may obtain motion information and determine the partitioning type associated with the video block based on motion information. Upon determining to disable the motion-derived split mode for the video block, the video encoding device may include an indication of the partition type associated with the video block in video data.

In an example, the CU level indicator may be decoded (e.g., only be decoded) when the high level flag as described herein is configured (e.g., set).

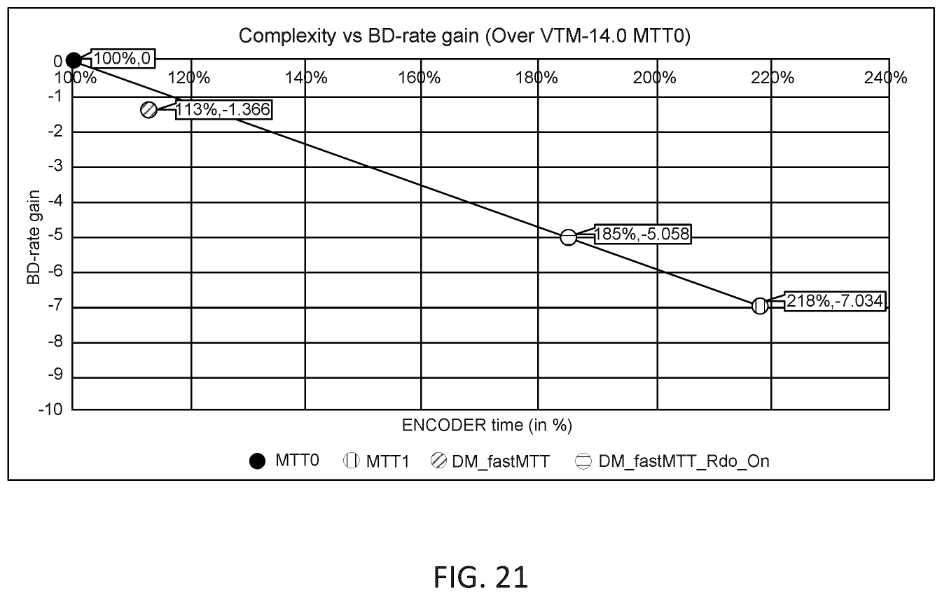

FIG. 21 illustrates data points showing benefits of an example technique as described herein. In FIG. 20, the plot illustrates four (4) data points MTT0, MTT1, DM_fastMTT and DM_fastMTT_Rdo_On. MTT0 may depict an example wherein an MTT tool may not be enabled (e.g., wherein an MTT tool may be disabled) and may be used as a reference point on the plot. MTT1 may depict an example wherein the MTT tool is enabled, and an encoding device (e.g., the encoder) may performs a brute-force technique to decide a best MTT split for a given CU block. The data points DM_fastMTT and DM_fastMTT_Rdo may use additional motion information and/or depth information (e.g., maps) from a game engine to speed up the MTT algorithm.

From the plot it may be observed that the data point DM_fastMTT may demonstrate a trade-off (e.g., a much better trade-off) in terms of the speed vs BD-rate gain when compared to other points on the plot (e.g., demonstrating merits to the technique).

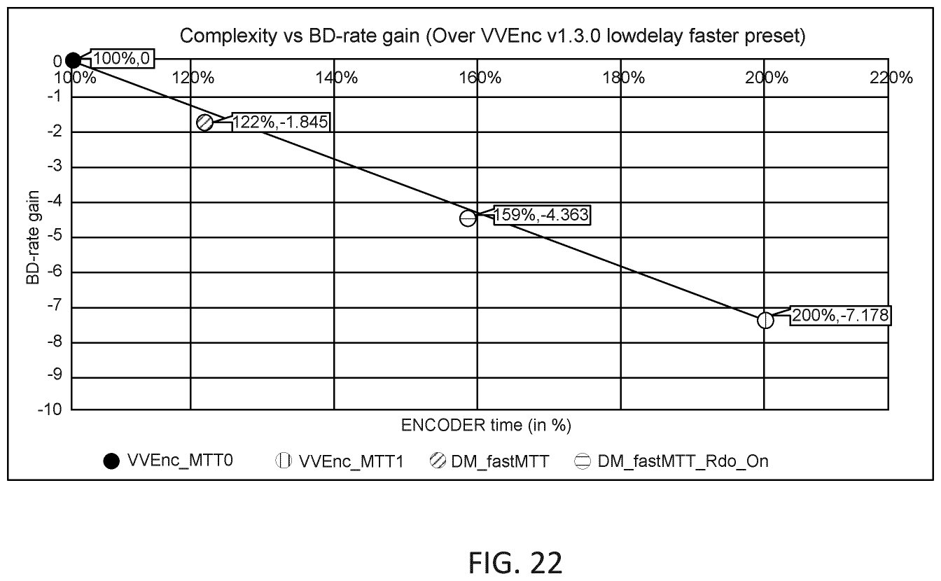

FIG. 22 illustrates similar gains (e.g., on vvenc-1.3.0 software) in an example making use of a video compression system).

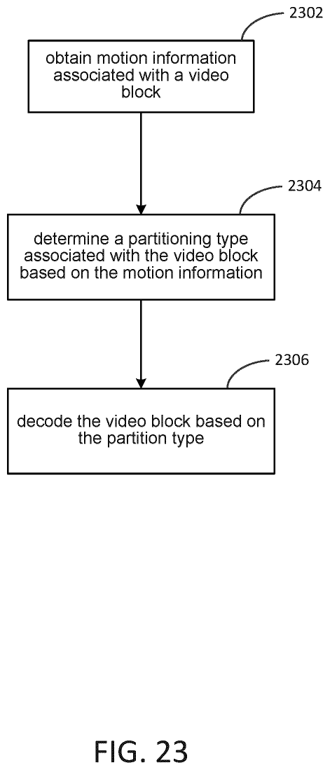

FIG. 23 illustrates an example of determining a partitioning type based on motion information. For example, at 2302, motion information associated with a video block may be obtained. For example, at 2304, a partitioning type associated with the video block may be. For example, at 2306, the video block may be processed.

While the examples provided herein may assume that media content is streamed to a display device, there is no specific restriction on the type of display device that may benefit from the example techniques described herein. For example, the display device may be a television, a projector, a mobile phone, a tablet, etc. Further, the example techniques described herein may apply to not only streaming use cases, but also teleconferencing settings. In addition, a decoder and a display as described herein may be separate devices or may be parts of a same device. For example, a set-top box may decode an incoming video stream and provide (e.g., subsequently) the decoded stream to a display device (e.g., via HDMI), and information regarding viewing conditions such as a viewing distance may be transmitted from the display device to the set-top box (e.g., via HDMI).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-46. (canceled)

47. A video decoding device, the device comprising:
a processor configured to:
obtain depth information associated with a video block;
determine, based on at least the depth information, a partitioning type associated with the video block; and
decode the video block in accordance with the determined partitioning type.

48. The device of claim 47, wherein the depth information associated with the video block comprises a depth block, and the processor is further configured to:
segment the depth block based on binary segmentation; and
determine the partitioning type of the video block based on the binary segmented depth block.

49. The device of claim 47, wherein the depth information associated with the video block comprises a depth block, and wherein the processor is further configured to:
segment the depth block based on binary segmentation;
obtain a gradient associated with the binary segmented depth block; and
determine the partitioning type of the video block based on at least the gradient associated with the binary segmented depth block.

50. The device of claim 47, wherein the depth information associated with the video block comprises a depth block, and wherein the processor is further configured to:
detect an edge in the depth block based at least on a vertical gradient and a horizontal gradient of the depth block; and
determine the partitioning type of the video block based on a position of the edge in the depth block.

51. The device of claim 47, wherein the depth information associated with the video block comprises a depth block, and wherein the processor is further configured to:
split the depth block into a plurality of parts;
determine respective scores associated with the plurality of parts based at least in part on a comparison of a sum of pixel depth values in a first part to a sum of pixel depth values in a second part; and
determine the partitioning type based on the respective scores.

52. The device of claim 47, wherein the depth information associated with the video block comprises a depth block, and wherein the processor is further configured to:
determine whether the depth block is homogenous; and
determine that the partitioning type for the video block is non-split based on a determination that the depth block is homogenous.

53. A method for video decoding, the method comprising:
obtaining depth information associated with a video block;
determining, based on at least the depth information, a partitioning type associated with the video block; and
decoding the video block in accordance with the determined partitioning type.

54. The method of claim 53, wherein the depth information associated with the video block comprises a depth block, and wherein the method further comprises:
segmenting the depth block based on binary segmentation; and
determining the partitioning type of the video block based on the binary segmented depth block.

55. The method of claim 53, wherein the depth information associated with the video block comprises a depth block, and wherein the method further comprises:
segmenting the depth block based on binary segmentation;
obtaining a gradient associated with the binary segmented depth block; and
determining the partitioning type of the video block based on at least the gradient associated with the binary segmented depth block.

56. The method of claim 53, wherein the depth information associated with the video block comprises a depth block, and wherein the method further comprises:
detecting an edge in the depth block based at least on a vertical gradient and a horizontal gradient of the depth block; and
determining the partitioning type of the video block based on a position of the edge in the depth block.

57. The method of claim 53, wherein the depth information associated with the video block comprises a depth block, and wherein the method further comprises:
splitting the depth block into a plurality of parts;
determining respective scores associated with the plurality of parts based at least in part on a comparison of a sum of pixel depth values in a first part to a sum of pixel depth values in a second part; and
determining the partitioning type based on the respective scores.

58. The method of claim 53, wherein the depth information associated with the video block comprises a depth block, and wherein the method further comprises:
determining whether the depth block is homogenous; and
determining that the partitioning type for the video block is non-split based on a determination that the depth block is homogenous.

59. A video encoding device, the device comprising:
a processor configured to:
obtain depth information associated with a video block;
determine, based on at least the depth information, a partitioning type associated with the video block; and
encode the video block in accordance with the determined partitioning type.

60. The device of claim 59, wherein the depth information associated with the video block comprises a depth block, and wherein the processor is further configured to:
segment the depth block based on binary segmentation; and
determine the partitioning type of the video block based on the binary segmented depth block.

61. The device of claim 59, wherein the depth information associated with the video block comprises a depth block, and wherein the processor is further configured to:
segment the depth block based on binary segmentation;
obtain a gradient associated with the binary segmented depth block; and
determine the partitioning type of the video block based on at least the gradient associated with the binary segmented depth block.

62. The device of claim 59, wherein the depth information associated with the video block comprises a depth block, and wherein the processor is further configured to:
detect an edge in the depth block based at least on a vertical gradient and a horizontal gradient of the depth block; and
determine the partitioning type of the video block based on a position of the edge in the depth block.

63. A method for video encoding, the method comprising:
obtaining depth information associated with a video block;
determining, based on at least the depth information, a partitioning type associated with the video block; and
encoding the video block in accordance with the determined partitioning type.

64. The method of claim 63, wherein the depth information associated with the video block comprises a depth block, and wherein the method further comprises:
segmenting the depth block based on binary segmentation; and
determining the partitioning type of the video block based on the binary segmented depth block.

65. The method of claim 63, wherein the depth information associated with the video block comprises a depth block, and wherein the method further comprises:
segmenting the depth block based on binary segmentation;
obtaining a gradient associated with the binary segmented depth block; and
determining the partitioning type of the video block based on at least the gradient associated with the binary segmented depth block.

66. The method of claim 63, wherein the depth information associated with the video block comprises a depth block, and wherein the method further comprises:
detecting an edge in the depth block based at least on a vertical gradient and a horizontal gradient of the depth block; and
determining the partitioning type of the video block based on a position of the edge in the depth block.
